(19) United States
(12) Patent Application Publication
(10) Pub. No.: US 2026/0154149 A1
(43) Pub. Date: Jun. 4, 2026

(54) CONTROLLER AND STORAGE DEVICE

(71) Applicant: SK hynix Inc., Icheon-si (KR)

(72) Inventors: Hui Won LEE, Icheon-si (KR); Taek Gyu LEE, Icheon-si (KR)

(21) Appl. No.: 19/176,846

(22) Filed: Apr. 11, 2025

(30) Foreign Application Priority Data
Dec. 4, 2024 (KR) 10-2024-0178020

(51) Int. Cl. G06F 11/07

(52) U.S. Cl. CPC G06F 11/0793; G06F 11/0709

(57) ABSTRACT

A reset request is set in advance to be transmitted to a host device through a hardware configuration of a controller when an unrecoverable error occurs in a storage device. Therefore, it is possible to provide a storage device capable of quickly and stably receiving a hardware reset signal from a host device and performing a fast recovery operation, and an operating method thereof.

### CROSS-REFERENCE TO RELATED APPLICATION

The present application claims priority under 35 U.S.C. § 119(a) to Korean Patent Application No. 10-2024-0178020 filed in the Korean Intellectual Property Office on Dec. 4, 2024, which is incorporated herein by reference in its entirety.

### BACKGROUND

### 1. Technical Field

Embodiments of the present disclosure generally relate to a controller and a storage device.

### 2. Related Art

A storage device may include at least one memory, which stores data. The storage device may include a controller that controls the operation of the at least one memory.

The controller may control the operation of the memory on the basis of a command received from an external device or its own command. For example, the controller may control an operation of writing data to the memory or reading data written to the memory according to a command received from the external device.

An error may occur during the operation of a storage device under the control of the controller. Control may be performed for recovering an error or for ensuring a return to the normal operation of the storage device in which an error has occurred, but resulting increases in delay time may deteriorate the operational performance of the storage device.

### SUMMARY

Various embodiments of the present disclosure are directed to providing measures capable of reducing delay time due to a recovery operation when an error occurs during the operation of a storage device and improving the operational performance of the storage device.

In an embodiment, a storage device may include: a memory; and a controller including a first control part that communicates with a host device and a second control part that controls the memory, wherein the second control part recognizes an occurrence of an unrecoverable error, transmits a reset request preparation signal to the first control part, and wherein after receiving the reset request preparation signal, the first control part transmits, to the host device, a response signal including information on a reset request and corresponding to a command stored in a first command queue for managing commands received from the host device.

In an embodiment, a storage device may include: a memory; and a controller configured to control the memory, store and manage commands received from a host device in a command queue, and, when an unrecoverable error is recognized, transmit a response signal, including information on a reset request, that corresponds to at least one command stored in the command queue to the host device.

In an embodiment, a controller may include: a first control part configured to communicate with a host device and store and manage a command received from the host device in a command queue; and a second control part configured to control the memory and transmit a reset request preparation signal to the first control part an unrecoverable error is recognized, wherein the first control part, when receiving the reset request preparation signal, transmits a response signal including information on a reset request and corresponding to the command stored in the command queue to the host device.

According to the embodiments of the present disclosure, it is possible to reduce time required for a recovery operation when an error occurs during the operation of a storage device and improve the operational performance of the storage device.

### BRIEF DESCRIPTION OF THE DRAWINGS

FIG. 1 is a diagram illustrating a schematic configuration of a storage device according to embodiments of the present disclosure.

FIG. 2 is a diagram illustrating a configuration of a memory included in a storage device according to the embodiments of the present disclosure.

FIG. 3 is a diagram illustrating an example of a reset operation method of a storage device according to embodiments of the present disclosure.

FIG. 4 is a diagram illustrating another example of a reset operation method of a storage device according to embodiments of the present disclosure.

FIG. 5 to FIG. 7 are diagrams illustrating examples of a method in which a storage device operates according to a reset operation method illustrated in FIG. 4.

FIG. 8 and FIG. 9 are diagrams illustrating examples of information that is transmitted by a storage device according to a reset operation method illustrated in FIG. 4.

FIG. 10 to FIG. 12 are diagrams illustrating examples of a method in which a storage device transmits a reset request according to a reset operation method illustrated in FIG. 4.

FIG. 13 is a diagram illustrating an example of an operation timing of a storage device according to a reset operation method illustrated in FIG. 10 to FIG. 12.

FIG. 14 and FIG. 15 are diagrams illustrating other examples of the reset operation method of the storage device according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance range or error margin that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

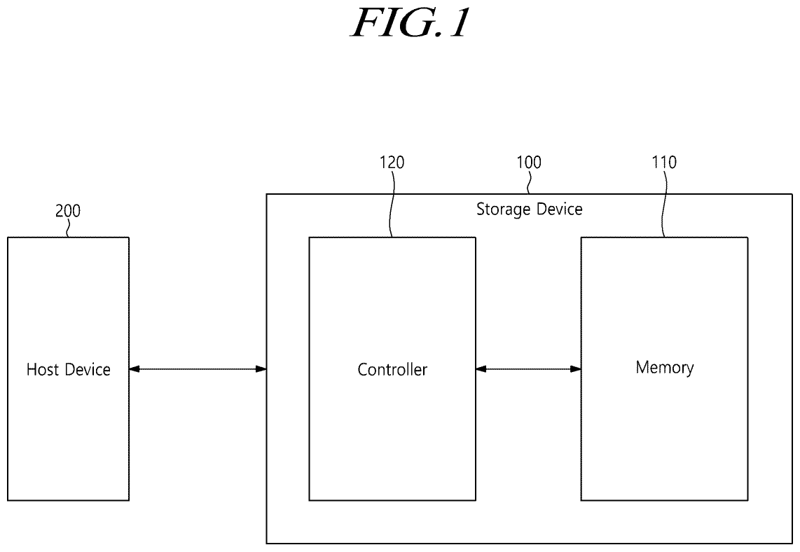

FIG. 1 is a diagram illustrating a schematic configuration of a storage device according to embodiments of the present disclosure.

Referring to FIG. 1, a storage device 100 may include at least one memory 110. The storage device 100 may include a controller 120, which controls the operation of the memory 110.

The memory 110 may be, for example, volatile memory such as DRAM, SDRAM, DDR SDRAM and LPDDR SDRAM, but embodiments of the present disclosure are not limited thereto. The memory 110 may be nonvolatile memory such as NAND flash memory, 3D NAND flash memory and NOR flash memory. Some parts of the memory 110 included in the storage device 100 may be volatile memory, while other parts of the memory 110 may be nonvolatile memory.

In addition, the memory 110 may be one of various types of memory such as resistive RAM, phase change memory, magnetoresistive memory, ferroelectric memory and spin transfer torque memory. The memory 110 may be processing-in-memory, which includes a computation function or a data processing function.

The memory 110 may include a plurality of storage blocks. Each of the plurality of storage blocks may include a plurality of memory cells. Two or more memory cells may constitute one page, and a plurality of pages may constitute one storage block.

The controller 120 may receive a command from the outside (i.e., from an external device), and may control the operation of the memory 110 on the basis of the received command. In addition, the controller 120 may control the operation of the memory 110 on the basis of an internally generated command. In the present specification, a command that the controller 120 receives from the outside may be referred to as an external command, and a command that is generated inside the controller 120 may be referred to as an internal command.

The controller 120 may control the operation of the memory 110 on the basis of the external command or the internal command. For example, the controller 120 may control an operation of writing data to the memory 110. The controller 120 may control an operation of reading data written to the memory 110. Data may be transmitted and received between the controller 120 and the memory 110.

Depending on the type of the memory 110, the controller 120 may control a data preservation operation (e.g., a refresh operation or a patrol scrub operation) or an erase operation on data written to the memory 110.

In order to maintain and improve the operational performance of the storage device 100, the controller 120 may perform a background operation associated with the memory 110 on the basis of an external command received from an external host device 200 or on the basis of an internal command. The background operation may include at least one among, for example, garbage collection, wear leveling, read reclaim and bad block management operations. Through control of the background operation, the controller 120 may improve the operational performance of the storage device 100 or prevent the operational performance of the storage device 100 from degrading.

The controller 120 may control the operation of the memory 110 on the basis of a command received from the host device 200. The controller 120 may provide the host device 200 with a processing result according to an operation corresponding to the command. The controller 120 may transmit data or a response signal to the host device 200.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, etc. Alternatively, the host device 200 may be a virtual/augmented reality device which provides a 2D or 3D virtual reality image or augmented reality image. In addition to the examples described above, the host device 200 may be any one of various electronic devices each of which requires a storage device 100 capable of storing data.

The host device 200 may include at least one operating system. The operating system may manage and control overall functions and operations of the host device 200, and may control the interoperation between the host device 200 and the storage device 100. The operating system may be classified into a general operating system and a mobile operating system depending on the mobility of the host device 200.

The controller 120 and the host device 200 may be devices that are separated from each other. The controller 120 and the host device 200 may be implemented by being integrated as one device, or some components or functions of the controller 120 may be implemented by being included in the host device 200. Below, for the sake of convenience in explanation, examples describe a controller 120 and the host device 200 as devices that are separated from each other.

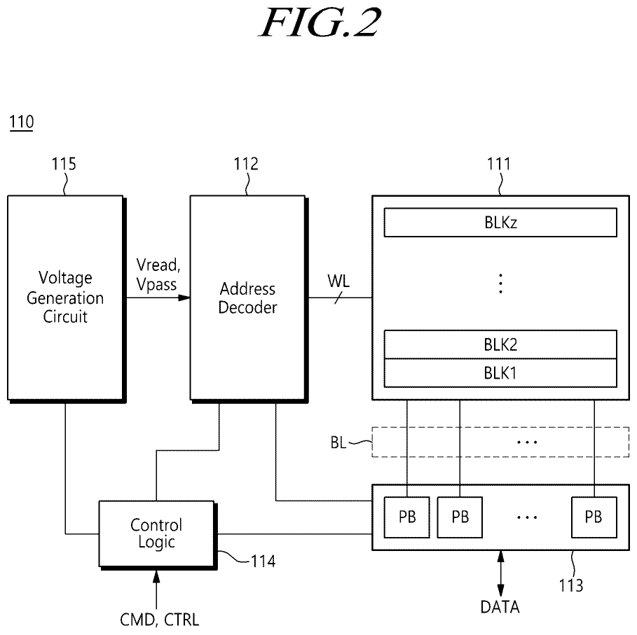

FIG. 2 is a diagram illustrating a configuration of a memory included in a storage device according to the embodiments of the present disclosure.

Referring to FIG. 2, a memory 110 according to the embodiments of the present disclosure may include a memory cell array 111, an address decoder 112, a read and write circuit 113, a control logic 114 and a voltage generation circuit 115.

The memory cell array 111 may include a plurality of storage blocks BLK1 to BLKz (where z is a natural number of 2 or more).

In the plurality of storage blocks BLK, a plurality of word lines WL and a plurality of bit lines BL may be disposed, and a plurality of memory cells may be arranged.

The plurality of storage blocks BLK may be connected to the address decoder 112 through the plurality of word lines WL. The plurality of storage blocks BLK may be connected to the read and write circuit 113 through the plurality of bit lines BL.

Each of the plurality of storage blocks BLK may include a plurality of memory cells. The plurality of memory cells may be nonvolatile memory cells, and may be configured with nonvolatile memory cells that have a vertical channel structure.

In some embodiments, the memory cell array 111 may be configured as a memory cell array with a two-dimensional structure, and in other embodiments, may be configured as a memory cell array with a three-dimensional structure.

Each of the plurality of memory cells included in the memory cell array 111 may store at least 1 bit of data. For example, each of the plurality of memory cells included in the memory cell array 111 may be a single-level cell (SLC), which stores 1 bit of data. In another example, each of the plurality of memory cells included in the memory cell array 111 may be a multi-level cell (MLC) that stores 2 bits of data, a triple-level cell (TLC) that stores 3 bits of data, a quad-level cell (QLC) that stores 4 bits of data or a memory cell that stores at least 5 bits of data.

The number of bits of data stored in each of the plurality of memory cells may be dynamically determined. For example, a single-level cell that stores 1 bit of data may be changed to a triple-level cell that stores 3 bits of data.

The address decoder 112, the read and write circuit 113, the control logic 114 and the voltage generation circuit 115 may operate as a peripheral circuit that drives the memory cell array 111.

The address decoder 112 may be connected to the memory cell array 111 through the plurality of word lines WL. The address decoder 112 may be configured to operate in response to control of the control logic 114.

The address decoder 112 may receive an address through an input/output buffer in the memory 110. The address decoder 112 may be configured to decode a block address in the received address. The address decoder 112 may select at least one storage block BLK according to the decoded block address.

The address decoder 112 may receive a read voltage Vread and a pass voltage Vpass from the voltage generation circuit 115.

In an operation of applying the read voltage Vread during a read operation, the address decoder 112 may apply the read voltage Vread to a selected word line WL in a selected storage block BLK, and may apply the pass voltage Vpass to remaining unselected word lines WL.

In a program verify operation, the address decoder 112 may apply a verify voltage generated in the voltage generation circuit 115 to a selected word line WL in a selected storage block BLK, and may apply the pass voltage Vpass to remaining unselected word lines WL.

The address decoder 112 may be configured to decode a column address in the received address. The address decoder 112 may transmit the decoded column address to the read and write circuit 113.

A read operation and a program operation of the memory 110 may be performed in the unit of a page. An address received when each of the read operation and the program operation is requested may include at least one of a block address, a row address and a column address.

The address decoder 112 may select one storage block BLK and one word line WL according to the block address and the row address. The column address may be decoded by the address decoder 112, and the decoded column address may be provided to the read and write circuit 113.

The address decoder 112 may include at least one of a block decoder, a row decoder, a column decoder and an address buffer.

The read and write circuit 113 may include a plurality of page buffers PB. The read and write circuit 113 may operate as a read circuit in a read operation of the memory cell array 111, and may operate as a write circuit in a write operation of the memory cell array 111.

The read and write circuit 113 may also be referred to as a page buffer circuit or a data register circuit that includes the plurality of page buffers PB. The read and write circuit 113 may include a data buffer that takes charge of a data processing function, and may additionally include a cache buffer which takes charge of a caching function.

The plurality of page buffers PB may be connected to the memory cell array 111 through the plurality of bit lines BL. In order to sense threshold voltages (Vth) of memory cells in a read operation and a program verify operation, the plurality of page buffers PB may continuously supply sensing current to bit lines BL connected to the memory cells, and may latch sensing data by sensing, through sensing nodes, changing amounts of current flowing according to programmed states of the corresponding memory cells.

The read and write circuit 113 may operate in response to page buffer control signals output from the control logic 114.

In a read operation, the read and write circuit 113 may temporarily store read data by sensing data of memory cells, and then, may output data DATA to the input/output buffer of the memory 110. As an exemplary embodiment, the read and write circuit 113 may include a column select circuit and so on in addition to the page buffers PB or page registers.

The control logic 114 may be connected to the address decoder 112, the read and write circuit 113 and the voltage generation circuit 115. The control logic 114 may receive a command CMD and a control signal CTRL through the input/output buffer of the memory 110.

The control logic 114 may be configured to control overall operations of the memory 110 in response to the control signal CTRL. The control logic 114 may output a control signal for adjusting the precharge potential level of the sensing nodes of the plurality of page buffers PB.

The control logic 114 may control the read and write circuit 113 to perform a read operation of the memory cell array 111. The voltage generation circuit 115 may generate the read voltage Vread and the pass voltage Vpass used in the read operation, in response to a voltage generation circuit control signal output from the control logic 114.

Each of the storage blocks BLK of the memory 110 described above may be composed of a plurality of pages corresponding to a plurality of word lines WL and a plurality of strings corresponding to a plurality of bit lines BL.

In the storage block BLK, the plurality of word lines WL and the plurality of bit lines BL may be disposed to intersect each other. A memory cell connected to one of the plurality of word lines WL and one of the plurality of bit lines BL may be defined. A transistor may be disposed in each memory cell.

A transistor disposed in a memory cell may include a drain, a source and a gate. The drain (or source) of the transistor may be connected to a corresponding bit line BL directly or via another transistor. The source (or drain) of the transistor may be connected to a source line (which may be the ground) directly or via another transistor. The gate of the transistor may include a floating gate that is surrounded by a dielectric and a control gate to which a gate voltage is applied from a word line WL.

In each storage block BLK, a first select line (also referred to as a source select line or a drain select line) may be additionally disposed outside a first outermost word line WL more adjacent to the read and write circuit 113 between two outermost word lines WL, and a second select line (also referred to as a drain select line or a source select line) may be additionally disposed outside a second outermost word line WL between the two outermost word lines WL.

In some embodiments, at least one dummy word line may be additionally disposed between the first outermost word line and the first select line. At least one dummy word line may also be additionally disposed between the second outermost word line and the second select line.

A read operation and a program operation (write operation) of the storage block BLK described above may be performed in the unit of a page, and an erase operation may be performed in the unit of a storage block BLK of the memory 110.

An error may occur during an operation such as a write, read or erase operation on a storage block BLK of the memory 110. An error may also occur in the operation of the controller 120, which controls the memory 110. Control for recovering an error may be performed by the controller 120. In some instances, error recovery by the controller 120 may not be possible or may be delayed.

The embodiments of the present disclosure may provide measures capable of controlling a reset operation of a storage device to prevent or minimize degradation of the operational performance of the storage device due to an error correction or recovery operation when an error occurs in the operation of the storage device.

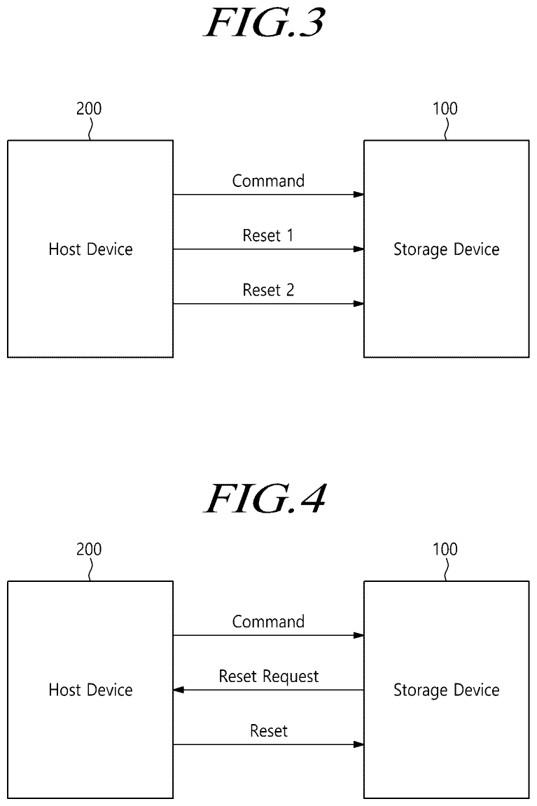

FIG. 3 is a diagram illustrating an example of a reset operation method of a storage device according to embodiments of the present disclosure.

FIG. 3 illustrates a reset operation of a storage device 100 is performed by a host device 200 during an operation of the storage device 100 according to a command of the host device 200.

For example, the host device 200 may transmit a command to the storage device 100. The storage device 100 may perform an operation based on the command received from the host device 200. Various errors may occur during the operation of the storage device 100. When an error occurs during the operation of the storage device 100, processing of the command received from the host device 200 may not be performed.

When there is no response to the command transmitted to the storage device 100, the host device 200 may transmit a reset signal to the storage device 100.

When a reception response for the command transmitted to the storage device 100 or when an operation completion response according to the command is not received, the host device 200 may transmit a reset signal to the storage device 100.

For example, the host device 200 may first transmit a first reset signal. The first reset signal may be a signal that requests or instructs reset of an operation for the command transmitted to the storage device 100 from the host device 200. Alternatively, the first reset signal may be a signal that requests or instructs reset of an operation for a task corresponding to the command transmitted to the storage device 100 by the host device 200. Alternatively, the first reset signal may be a signal which requests or instructs reset of a logic unit associated with a task including the command transmitted to the storage device 100 by the host device 200. Alternatively, the first reset signal may be a hardware reset signal that requests reset of the storage device 100.

The host device 200 may wait for a response from the storage device 100 after transmitting the first reset signal. When a response from the storage device 100 is not received after transmitting the first reset signal, the host device 200 may transmit a second reset signal to the storage device 100.

The second reset signal may be a signal that requests reset of a unit larger than the unit of the reset requested by the first reset signal. For example, when the first reset signal is a signal that requests reset of a task, the second reset signal may be a signal that requests reset of a logic unit or hardware. In another example, when the first reset signal is a signal that requests reset of a logic unit, the second reset signal may be a signal that requests reset of hardware.

When there is no response to the command from the storage device 100, the host device 200 may sequentially transmit the first reset signal and the second reset signal. Although in this example the host device 200 transmits two types of reset signals, the host device 200 may sequentially transmit at least three types of reset signals or may repeatedly transmit the same type of reset signals.

After transmitting a command, the host device 200 may transmit a reset signal according to a preset condition. For example, when a response from the storage device 100 is not received within a predetermined time period after transmitting the command, the host device 200 may transmit a reset signal to the storage device 100.

The predetermined time period may be a time period that is fixed for all commands, or may be a time period that is determined according to the type of a command that the host device 200 transmits to the storage device 100.

When the host device 200 transmits a plurality of commands to the storage device 100, the predetermined time period may start at a time point at which a first command is transmitted or may start at a time point at which a last command is transmitted.

When a response from the storage device 100 is not generated for the predetermined time period after transmitting a command to the storage device 100, the host device 200 may transmit a reset signal to the storage device 100 to perform control for recovery of the storage device 100. As a result of the reset signal from the host device 200, the storage device 100 may enter a normal operation state again.

The embodiments of the present disclosure may provide measures for performing a faster recovery operation when an error occurs by requesting transmission of a reset signal to the host device 200 when the storage device 100 does not process an operation according to a command of the host device 200.

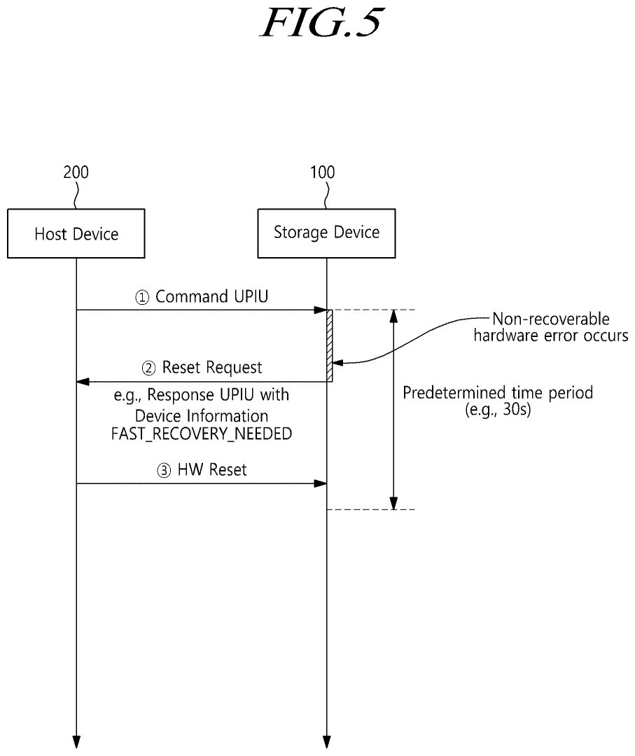

FIG. 4 is a diagram illustrating another example of a reset operation method of a storage device according to embodiments of the present disclosure.

### Referring to FIG. 4, a host device 200 may transmit to a storage device 100 a command that requests an operation of the storage device 100.

The storage device 100, which receives the command from the host device 200, may perform an operation according to the command. The storage device 100 may monitor the operation state of the storage device 100, and may check whether an unrecoverable error of the storage device 100 occurs. Such control of the storage device 100 may be performed by the controller 120 of the storage device 100.

Situations may vary in which an unrecoverable error occurs in the storage device 100. For example, there may be a situation where the storage device 100 stops as an unusual exceptional case, a situation where it is determined that the storage device 100 cannot operate due to malfunction of hardware such as the bit flip of a cache memory or a buffer memory included in the storage device 100, a situation where it is determined that it is impossible to process another command due to occurrence of a timeout in an internal operation of the storage device 100 or a situation where a task management unit is received from the host device 200. However, in addition to the examples described above, a situation in which the storage device 100 cannot operate normally or cannot process a command from the host device 200 may be included as an unrecoverable error situation according to embodiments of the present disclosure.

When an unrecoverable error situation occurs, the storage device 100 may transmit a signal that requests transmission of a reset signal to the host device 200 for a faster recovery operation.

For example, the storage device 100 may transmit, to the host device 200, a signal requesting transmission of a reset signal for a task or a logic unit. The storage device 100 may transmit, to the host device 200, a signal requesting transmission of a hardware reset signal. The type of a reset signal that the storage device 100 requests from the host device 200 is not limited, and may include at least one of various reset signals that the storage device 100 may receive from the host device 200 when an unrecoverable error situation occurs.

The storage device 100 may transmit a signal requesting transmission of a reset signal to the host device 200 once or repeatedly. The storage device 100 may also transmit a signal requesting transmission of a reset signal to the host device 200 at regular time intervals.

The storage device 100 may transmit a request for transmission of a reset signal to the host device 200 using various types of signals.

For example, the storage device 100 may request transmission of a reset signal through a response signal, which is transmitted to the host device 200 according to a command of the host device 200.

Alternatively, the storage device 100 may request transmission of a reset signal to the host device 200 through a separately defined signal.

Alternatively, the storage device 100 may request transmission of a reset signal to the host device 200 using a type of signal that may be transmitted through an interface for communication with the host device 200 or using at least one of signal lines between the storage device 100 and the host device 200.

A method in which the storage device 100 requests transmission of a reset signal to the host device 200 is not limited to the examples described above and may vary in embodiments of the disclosure.

Embodiments of the present disclosure may include a storage device 100 that uses at least one of various types of signals that may be transmitted to the host device 200 when an unrecoverable error of the storage device 100 occurs, before the storage device 100 receives a reset signal from the host device 200.

When an unrecoverable error occurs after receiving a command from the host device 200, delay in the operation of the storage device 100 may be reduced if the storage device 100 requests transmission of a reset signal to the host device 200 before receiving a reset signal.

For example, the host device 200 may transmit a reset signal to the storage device 100 when there is no response from the storage device 100 after transmitting a command, or the host device 200 may transmit a reset signal to the storage device 100 when there is no request for transmission of a reset signal. Thus, even if a reset signal transmission request is not generated by the storage device 100, the storage device 100 can still address an unrecoverable error situation.

When an unrecoverable error of the storage device 100 occurs, the storage device 100 and the host device 200 may perform control for the normal operation of the storage device 100 through requesting transmission of a reset signal or transmitting a reset signal.

In this case, for example, operations of the storage device 100 and the host device 200 may be performed based on a time elapsed after the host device 200 transmits a command to the storage device 100.

FIG. 5 to FIG. 7 are diagrams illustrating examples of a method in which a storage device operates according to a reset operation method illustrated in FIG. 4.

Referring to FIG. 5, a host device 200 may transmit a command unit to a storage device 100 (\textcircled{1}). The command unit UPIU may be, for example, a command that requests writing of data to the storage device 100 or requests reading of data written to the storage device 100. Alternatively, the command unit may be a command that requests performing of a calculation in the storage device 100 using data stored in the storage device 100. In this case, the storage device 100 may perform the calculation according to the command of the host device 200 and return a result value according to the calculation to the host device 200.

After the storage device 100 receives the command unit from the host device 200, an unrecoverable error may occur in the storage device 100. The unrecoverable error may include at least one of the errors described above.

The storage device 100 may monitor whether an unrecoverable error occurs before a predetermined time period elapses after receiving the command unit from the host device 200. The predetermined time period may be, for example, 30 seconds, but embodiments are not limited thereto.

When occurrence of an unrecoverable error is checked before the predetermined time period elapses after receiving the command unit, the storage device 100 may transmit to the host device 200 a hint, which requests transmission of a reset signal (\textcircled{2}).

The storage device 100 may request, through the hint, transmission of a signal that instructs reset of the command unit, a task associated with the command unit or a logic unit including a task. Alternatively, through the hint, the storage device 100 may request transmission of a signal that instructs reset of hardware.

When an unrecoverable error of the storage device 100 occurs, it may be difficult to control for a normal state of the storage device 100 using a signal by which the host device 200 instructs reset of a task or a logic unit. Therefore, when an unrecoverable error is checked within the predetermined time period after receiving the command unit, the storage device 100 may transmit, to the host device 200, a hint that requests a signal instructing reset of hardware, so that fast recovery of the storage device 100 is possible.

The storage device 100 may transmit a hint requesting transmission of a reset signal, for example, using any one of fields included in a response signal to be transmitted to the host device 200. The response signal may be a signal transmitted in a response of a command received from the host device 200. For example, the storage device 100 may transmit a hint requesting transmission of a reset signal using at least a part of a device information field included in the response unit. Alternatively, the storage device 100 may request transmission of a reset signal to the host device 200 by using at least one of an exception event control attribute and an exception event status attribute, which constitute an exception event.

Alternatively, the storage device 100 may request transmission of a hardware reset signal through a signal that requests initialization of a communication interface between the host device 200 and the storage device 100. The signal that requests initialization may not be a signal transmitted in a response to a command from the host device 200. Without the command, the signal that requests initialization may be transmitted.

Alternatively, the storage device 100 may request transmission of a hardware reset signal by changing the signal level of at least one of signal lines that physically connect the host device 200 and the storage device 100. The changing the signal level may be performed without a command received from the host device 200.

When receiving a hint requesting transmission of a reset signal within the predetermined time period after transmitting the command unit to the storage device 100, the host device 200 may transmit a reset signal to the storage device 100 (\textcircled{3}).

The host device 200 may receive a hint that requests transmission of a reset signal even if a response signal corresponding to the command unit is not received from the storage device 100. According to the request from the storage device 100, the host device 200 may transmit to the storage device 100 a signal which instructs reset of hardware.

According to the request of the storage device 100 and the reset signal transmission of the host device 200 responding to the request of the storage device 100, control for the occurrence of an unrecoverable error in the storage device 100 within the predetermined time period after the command unit is transmitted may be performed with less delay. It is possible to reduce delay in processing of the command from the host device 200 and the operation of the storage device 100 due to an error of the storage device 100. The host device 200 may transmit the reset signal before the predetermined time period is passed.

In other embodiments, the storage device 100 does not transmit a hint, which requests transmission of a reset signal to the host device 200 within the predetermined time period after receiving the command unit from the host device 200. For example, the host device 200 may transmit a control signal for recovery of the storage device 100 to the storage device 100 when the predetermined time period elapses.

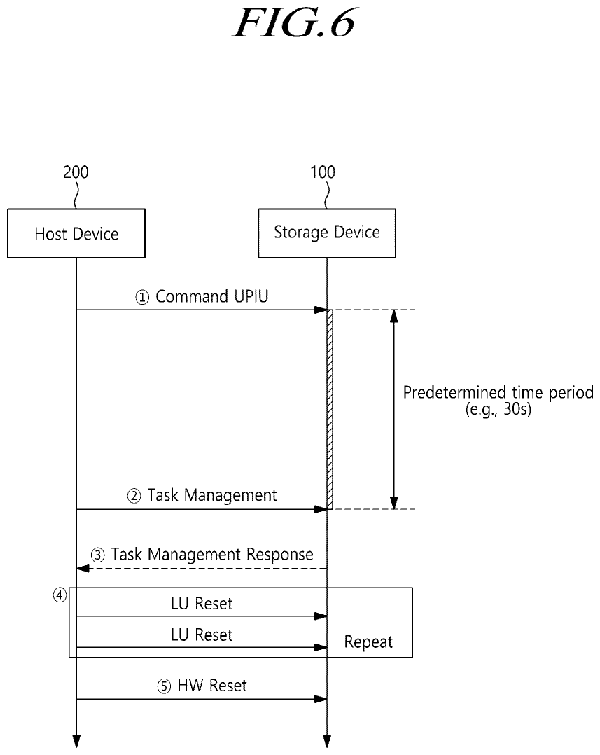

For example, referring to FIG. 6, the host device 200 may transmit a command unit to the storage device 100 (\textcircled{1}). The command unit may include at least one of the commands that instruct various operations of the storage device 100.

An unrecoverable error may occur in the storage device 100, which receives the command unit. Due to occurrence of the unrecoverable error, the storage device 100 may not transmit a response signal to the command unit of the host device 200. A predetermined time period may elapse, during which the storage device 100 does not transmit a response signal to the command unit.

When a response signal corresponding to the command unit or a hint requesting transmission of a reset signal is not received within the predetermined time period after transmitting the command unit to the storage device 100, the host device 200 may transmit a signal instructing reset to the storage device 100.

For example, when the predetermined time period elapses after transmitting the command unit, the host device 200 may transmit a task management unit to the storage device 100 (\textcircled{2}). For example, the task management unit may instruct the storage device 100 not to process the command unit transmitted from the host device 200. The task management unit may instruct the storage device 100 to operate without processing the previously received command unit at (\textcircled{1}).

In response to the task management unit from the host device 200, when the storage device 100 does not perform processing on the previously received command unit, the storage device 100 may transmit a response signal to the task management unit to the host device 200 (\textcircled{3}).

When receiving a response signal corresponding to the task management unit at (\textcircled{3}), the host device 200 may transmit a new command unit and request the storage device 100 to process the new command unit.

When the unrecoverable error occurs, however, the storage device 100 may not transmit a response signal to the task management unit of the host device 200.

Therefore, when a response signal to the task management unit is not received from the storage device 100, the host device 200 may transmit, to the storage device 100, a signal that instructs reset of a logic unit LU Reset including a plurality of tasks (\textcircled{4}).

The signal instructing reset of the logic unit instructs the storage device 100 not to process the command unit, which was previously transmitted by the host device 200 and is included in the logic unit. The host device 200 may repeatedly transmit a signal which instructs reset of a logic unit.

When the host device 200 does not receive a response signal from the storage device 100 in response to a signal instructing reset of a logic unit, the host device 200 may transmit to the storage device 100 a signal instructing hardware reset HW Reset of the storage device 100 (\textcircled{5}).

The reset of the storage device 100 may be performed by the hardware reset signal of the host device 200. When an unrecoverable error of the storage device 100 occurs, through hardware reset of the storage device 100 at (\textcircled{5}), the storage device 100 may operate normally again and may be brought into a state where the storage device 100 may process a command unit of the host device 200.

Even when the unrecoverable error occurs and the storage device 100 does not transmit, to the host device 200, a reset request signal within the predetermined time period after receiving the command unit, recovery of the storage device 100 may be performed by a reset signal transmitted by the host device 200 after the predetermined time period. The host device 200 may sequentially transmit a task management unit, a logic unit reset signal and a hardware reset signal as in the examples described above, or may transmit a logic unit reset signal or a hardware reset signal in a different order. The logic unit reset signal or the hardware reset signal may be transmitted earlier than the task management unit.

In other embodiments, even when the host device 200 receives a hint requesting transmission of a reset signal from the storage device 100, the host device 200 may control the operation of the storage device 100 while transmitting various reset signals to the storage device 100 before or after the expiration of the predetermined time period.

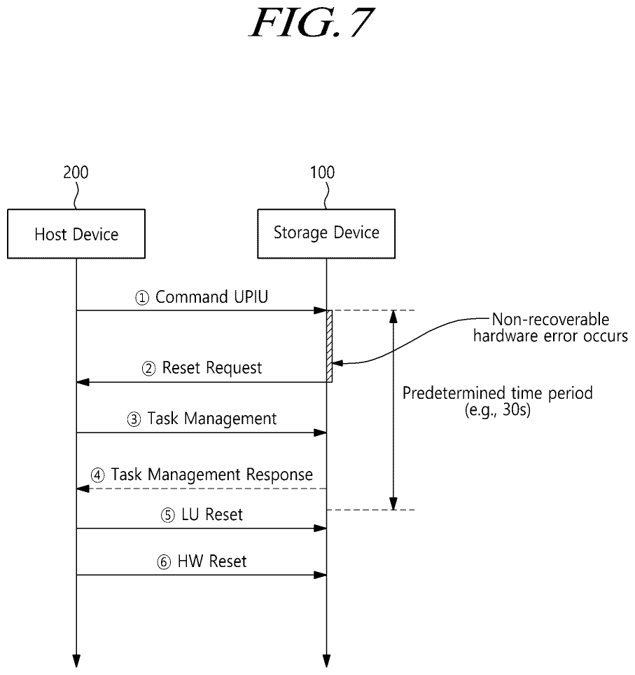

For example, referring to FIG. 7, the host device 200 may transmit a command unit to the storage device 100 (\textcircled{1}).

An unrecoverable error of the storage device 100 may occur. The storage device 100 may transmit, to the host device 200, a hint that requests transmission of a reset signal, within a predetermined time period after receiving the command unit (\textcircled{2}).

When receiving the hint, which requests transmission of a reset signal, the host device 200 may transmit a task management unit to the storage device 100 (\textcircled{3}). The host device 200 may receive a response signal corresponding to the task management unit from the storage device 100 (\textcircled{4}).

When the host device 200 does not receive a response signal corresponding to the task management unit, the host device 200 may transmit a signal instructing reset of a logic unit to the storage device 100 (\textcircled{5}). The host device 200 may repeatedly transmit a signal that instructs reset of a logic unit.

When the host device 200 does not receive a response signal from the storage device 100, the host device 200 may transmit a signal instructing hardware reset to the storage device 100 (\textcircled{6}). The hardware reset may be transmitted after a certain period of time. Alternatively, the hardware reset may be transmitted after a predetermined number of logic reset signals are sent.

In various embodiments, when receiving a hint requesting transmission of a reset signal from the storage device 100, the host device 200 may immediately transmit a hardware reset signal or may sequentially transmit a task management unit, a logic unit reset signal and a hardware reset signal, or the host device 200 may transmit a signal instructing reset of the storage device 100 within the predetermined time period after transmitting the command unit or after the predetermined time period elapses.

Therefore, the operation of the host device 200 may vary to achieve a faster recover when the storage device 100 transmits a hint requesting transmission of a reset signal due to occurrence of an recoverable error within the predetermined time period after receiving the command unit.

If a hint by the storage device 100 is not transmitted within the predetermined time period, then a reset signal transmission process by the host device 200 may proceed. Thus, even when a request by the storage device 100 is not generated within a predetermined time period, a recovery procedure by the host device 200 may be performed.

A hint, from the storage device 100, requesting transmission of a reset signal may be transmitted in various ways. For example, transmission of a reset signal may be requested using a response signal, transmitted to the host device 200 from the storage device 100, but transmission of a reset signal may also use an unused bit of an exception event.

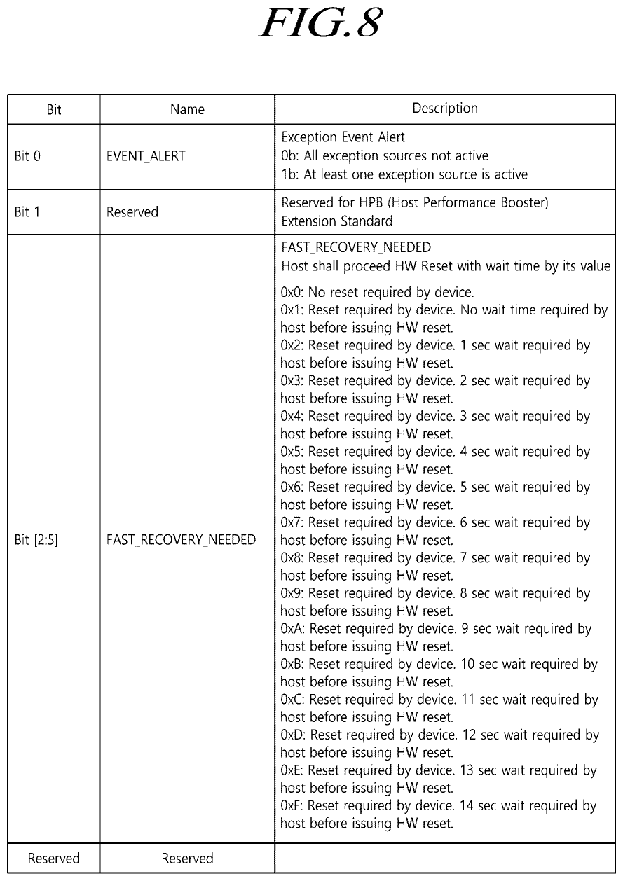

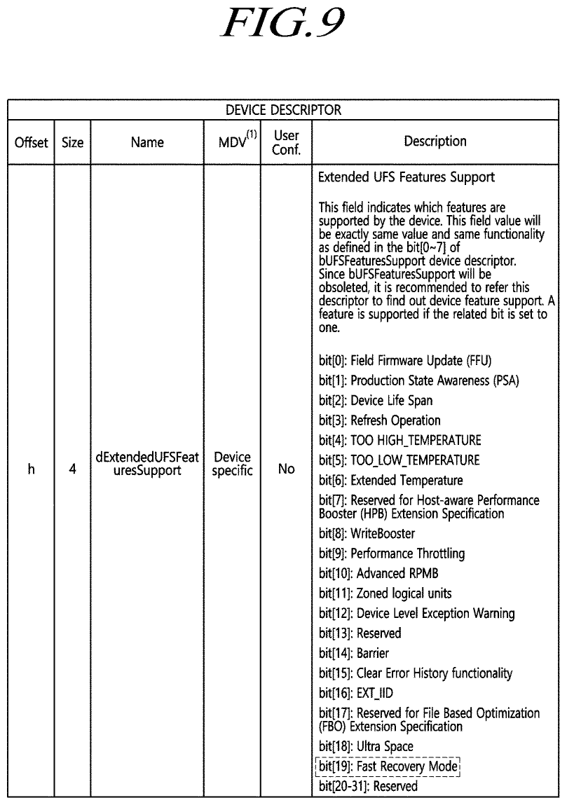

FIG. 8 and FIG. 9 are diagrams illustrating examples of information that is transmitted by a storage device according to a reset operation method illustrated in FIG. 4.

FIG. 8 illustrates a hint, which requests transmission of a reset signal that is transmitted to the host device 200 using a device information field, which is included in a response unit to be transmitted to the host device 200 from the storage device 100.

The storage device 100 may transmit the hint (information related to a reset request or the reset request) using a response unit to be transmitted to the host device 200. The response unit may be transmitted in response to a command unit previously received from the host device 200. Alternatively, the storage device 100 may generate a response unit for transmitting the hint, and may transmit the hint to the host device 200 using the response unit.

The device information field may provide information at a device level, and is associated with a logic unit executing a command and is not necessarily needed. For example, the information provided by the device information field may be information on an event that changes more slowly than a general command or information for which a response delay of the host device 200 is not important or irrelevant. The use of the device information field may avoid execution of continuous polling for some UFS attributes.

The bits 0 and [2:5] of the device information field may be defined. The bit 1 of the device information field may be reserved for a host performance booster (HPB) extension standard. The other bits of the device information field may be reserved and be set to 0.

The bits [2:5] of the device information field included in the response unit may be used to indicate whether a fast recovery operation is required.

For example, when the value of the bits [2:5] of the device information field is 0x0, that value may indicate that no reset is required by the storage device 100. Therefore, when the value of the bits [2:5] of the device information field included in the response unit transmitted from the storage device 100 to the host device 200 is 0x0, the host device 200 may recognize that the storage device 100 is not transmitting a hint requesting a hardware reset signal.

When the value of the bits [2:5] of the device information field is other than 0x0, the value may indicate that a hardware reset signal is requested by the storage device 100. The value of the bits [2:5] of the device information field may also indicate a wait time before transmitting a hardware reset signal in addition to whether a hardware reset signal is requested.

For example, when the value of the bits [2:5] of the device information field is 0x1, the value may indicate that a reset is required by the storage device 100. The host device 200 may recognize the value as a hint for requesting a hardware reset signal when the hint is received from the storage device 100. The value of the bits [2:5] from the storage device 100 may indicate that a fast recovery is needed.

When the value of the bits [2:5] of the device information field is 0x1, the host device 200 may recognize that there is no wait time required before generating a hardware reset signal. When the value of the bits [2:5] of the device information field included in the response unit received from the storage device 100 is 0x1, the host device 200 may recognize that a request for a hardware reset signal is generated by the storage device 100, and may transmit the hardware reset signal to the storage device 100 with no wait time.

When the value of the bits [2:5] of the device information field is other than 0x0 and 0x1, the value may indicate that there is a wait time before the host device 200 generates a hardware reset signal.

For example, when the value of the bits [2:5] of the device information field is 0x2, the value may indicate that reset is requested by the storage device 100 and a wait time before generation of a hardware reset signal by the host device 200 is 1 second.

When the value of the bits [2:5] of the device information field included in the response unit received from the storage device 100 is 0x2, the host device 200 may transmit a hardware reset signal to the storage device 100 after 1 second. Alternatively, the host device 200 may transmit a hardware reset signal to the storage device 100 within 1 second after receiving the response unit, which includes the device information field from the storage device 100.

Similarly, depending on the value of the bits [2:5] of the device information field, a wait time required by the host device 200 before generating a hardware reset signal may be set differently.

When receiving information requesting a reset from the storage device 100 as in the examples described above, the host device 200 may transmit, which is a hardware reset signal to the storage device 100 after a wait time set according to the value of the bits [2:5] of the device information field. Alternatively, the host device 200 may transmit a hardware reset signal to the storage device 100 within a set wait time.

When the value of the bits [2:5] of the device information field is 0xF, a wait time before generation of a hardware reset signal by the host device 200 may be set to 14 seconds. 14 seconds may be a maximum wait time, but embodiments of the present disclosure are not limited thereto.

Before a predetermined time period elapses after a command is transmitted by the host device 200, the storage device 100 may request transmission of a hardware reset signal for a fast recovery operation to the host device 200 through the device information field.

The storage device 100 may set a wait time for the host device 200, and even when a wait time is set, a reset operation of the storage device 100 by a hardware reset signal of the host device 200 may be possible within a time period shorter than the predetermined time period. For example, after transmitting the response unit including the device information field, the storage device 100 may not receive the hardware reset signal during the wait time. After the wait time, the storage device 100 may receive the hardware reset signal from the host device 200. the storage device 100 may perform an operation performed during an idle time period, such as a background operation, during the wait time by the host device 200.

In the above-described example, the value of the bits [2:5] of the device information field sets a wait time for the host device 200, in one second increments, before generating a hardware reset signal, but in other embodiments, a wait time may be set in different units of time such as 0.1 second, 0.5 second, 2 seconds, etc.

In addition, although the above examples use the bits [2:5] of the device information field to indicate whether a hardware reset signal and a wait time are requested, information for requesting transmission of a hardware reset signal and wait time may be transmitted using at least some of other bits that are not set for other uses, from among the bits of the device information field.

Whether such a fast recovery mode is supported may be indicated by an extended UFS feature support of the storage device 100.

For example, referring to FIG. 9, whether a fast recovery mode is supported may be indicated by a device descriptor. For example, whether the storage device 100 supports a fast recovery mode may be indicated by setting of the bit 19 of the extended UFS feature support of the device descriptor. Alternatively, whether the fast recovery mode is supported may be indicated using at least one bit other than the bit 0 to the bit 18 of the extended UFS feature support.

When the storage device 100 supports a fast recovery, mode, depending on the setting value of the fast recovery mode wait time, a hint requesting transmission of a reset signal may be transmitted to the host device 200 within a predetermined time period. The host device 200, which receives the hint according to the fast recovery method attribute, may transmit a reset signal to the storage device 100.

When the storage device 100 is in a state in which it cannot operate normally when fast recovery is required, various setting methods of transmitting a reset request for fast recovery may be provided that depend on the state of the storage device 100.

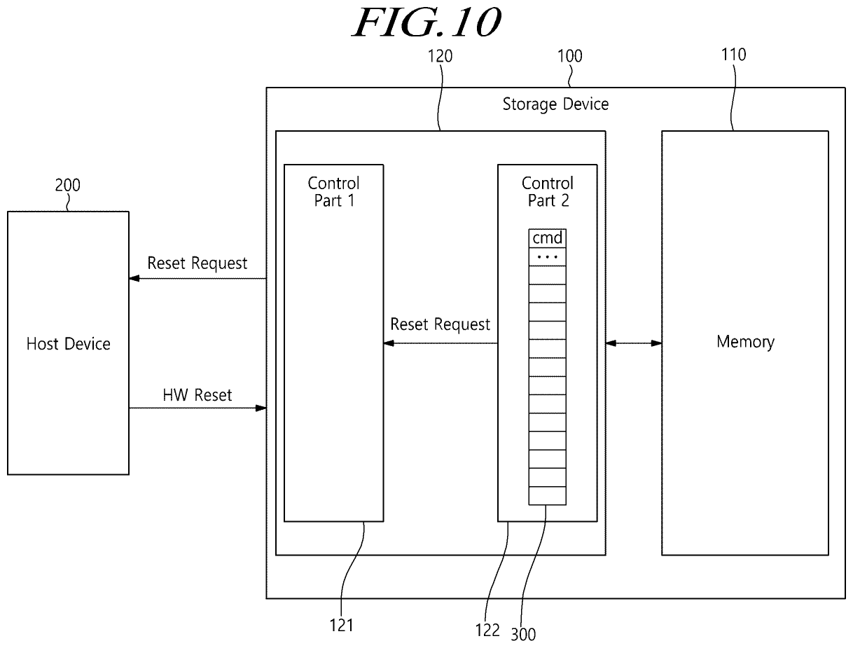

FIG. 10 to FIG. 12 are diagrams illustrating examples of a method in which a storage device transmits a reset request according to a reset operation method illustrated in FIG. 4.

Referring to FIG. 10, a controller 120 of a storage device 100 may include a first control part 121 and a second control part 122. The first control part 121 and the second control part 122 may be, for example, parts that can be distinguished from each other within one chip. Alternatively, the first control part 121 and the second control part 122 may be implemented as separate chiplets. The first control part 121 and the second control part 122 may be connected to form the controller 120.

The first control part 121 may communicate with the host device 200. The first control part 121 may transmit a command and data received from the host device 200 to the second control part 122. The first control part 121 may include an interface for communication with the host device 200. The first control part 121 may include a logic for controlling transmission and reception of data or a signal to and from the host device 200. The first control part 121 may include a buffer, which is used when transmitting and receiving data or a signal, to and from the host device 200 and the second control part 122.

The second control part 122 may communicate with the memory 110. The second control part 122 may control a memory 110. The second control part 122 may execute, for example, firmware for driving the memory 110. The second control part 122 may control the operation of the memory 110 according to the execution of the firmware.

The second control part 122 may communicate with the first control part 121. The second control part 122 may receive, from the first control part 121, a command or data transmitted by the host device 200. The second control part 122 may perform control on the memory 110 according to the received command or data. According to a command of the host device 200, the second control part 122 may control an operation of writing data to the memory 110 or reading data written to the memory 110. The second control part 122 may also control a background operation for improving the performance of the memory 110.

The second control part 122 may include a command queue 300 for managing commands cmd received through the first control part 121. The second control part 122 may store commands in the command queue 300, and may process the stored commands sequentially or non-sequentially. The second control part 122 may perform an operation for a command stored in the command queue 300, and when processing of the command is completed, may delete the command stored in the command queue 300.

The command queue 300 may include, for example, a plurality of slots. The number of the plurality of of slots may be, for example, 128, but embodiments are not limited thereto. A command may be stored in each of the plurality of slots included in the command queue 300 and may be processed.

The second control part 122 may recognize occurrence of an unrecoverable error in the memory 110 or the storage device 100 during operation. A situation in which occurrence of an unrecoverable error is predicted may be recognized by firmware, which is driven in the second control part 122.

When occurrence of an unrecoverable error is recognized, the second control part 122 may output a reset request, which requests transmission of a reset signal. The second control part 122 may output the reset request, for example, through a response signal corresponding to any one of commands stored in the command queue 300. The response signal may be a response unit corresponding to a command unit transmitted by the host device 200.

The second control part 122 may output a response signal corresponding to a command whose processing is completed, from among commands stored in the command queue 300, by including information in the response signal regarding a reset request. A method in which information on a reset request is included in a response signal may be various. As in the examples described above, information on a reset request may be transmitted through the device information field of a response unit.

The second control part 122 may transmit, to the first control part 121, a response signal that corresponds to a command whose processing is completed and may include information on a reset request in the response signal. The first control part 121 may transmit, to the host device 200, the response signal received from the second control part 122, which includes the information on a reset request. The host device 200 may check the information for a reset request included in the received response signal. The host device 200 may perform an operation for fast recovery. The host device 200 may transmit a hardware reset signal to the storage device 100 before a predetermined time period elapses for a recovery operation, without waiting for the predetermined time period to expire.

From among the commands stored in the command queue 300, the second control part 122 may output a reset request through a response signal corresponding to a command whose processing is not completed. When occurrence of an unrecoverable error is recognized or predicted, the second control part 122 may output a response signal corresponding to at least one command among commands included in the command queue 300. The response signal may include information on a reset request.

A response signal including information on a reset request may be transmitted to the first control part 121 by the second control part 122, and the first control part 121 may transmit the response signal including the information on a reset request to the host device 200.

The host device 200 may check the information on a reset request included in the response signal, and may transmit a hardware reset signal to the storage device 100. The storage device 100 may perform a fast recovery operation by performing a reset operation according to the hardware reset signal received from the host device 200 when occurrence of an unrecoverable error is recognized or predicted.

The second control part 122 may output response signals corresponding to all commands stored in the command queue 300. Each of the response signals may include information about a reset request. Information regarding a reset requests included in the respective response signals may be the same. The response signals outputted by the second control part 122 may be transmitted to the host device 200 through the first control part 121. A hardware reset signal may be transmitted by the host device 200, after checking the response signals, and a fast recovery operation of the storage device 100 may be performed.

When there is no command stored in the command queue 300, the second control part 122 may wait until a new command is received from the host device 200. When a new command is received and stored in the command queue 300, the second control part 122 may output a response signal in response to the corresponding command. A response signal including information about a reset request may be provided to the host device 200.

In this way, the second control part 122 may transmit a reset request to the host device 200 through the output of a response signal corresponding to a command.

The second control part 122 may not be able to output a response signal corresponding to a command due to an unrecoverable error. In this case, the second control part 122 may set, in advance, transmission of a response signal through the first control part 121. This transmission resulting from the setting in advance results in output of a reset request by the first control part 121.

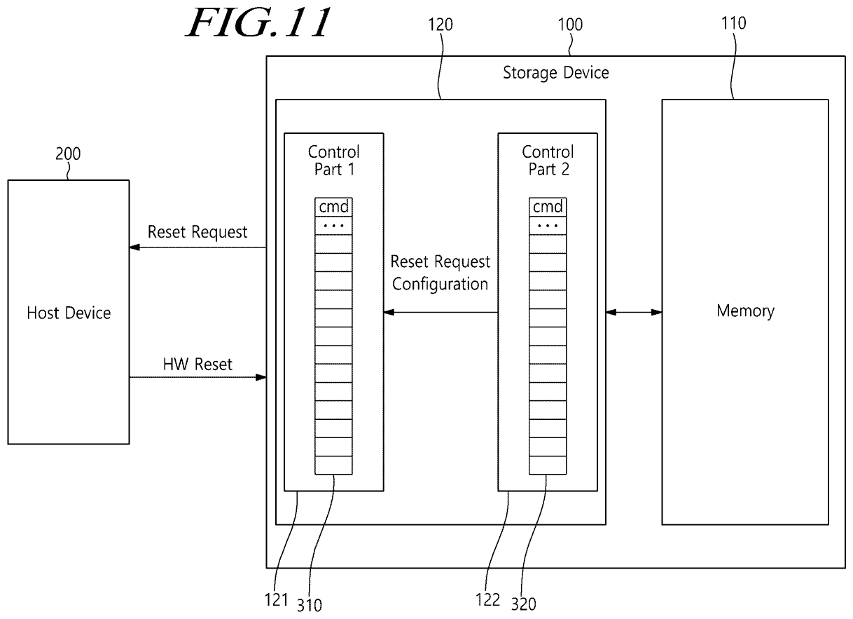

For example, referring to FIG. 11, the controller 120 of the storage device 100 may include a first control part 121 and a second control part 122. The first control part 121 may communicate with the host device 200. The second control part 122 may communicate with the memory 110.

The first control part 121 may provide a command and data received from the host device 200 to the second control part 122. The second control part 122 may control the operation of the memory 110 on the basis of the received command and data, and may process the command of the host device 200.

The first control part 121 may include a first command queue 310 for managing commands received from the host device 200. The second control part 122 may include a second command queue 320 for managing commands received from the host device 200.

The second control part 122 may manage commands while sequentially or non-sequentially processing commands stored in the second command queue 320. The second control part 122 may delete, from the second command queue 320, a command for which processing is completed. When processing of a command stored in the second command queue 320 is completed, the second control part 122 may transmit a response signal (a response unit) corresponding to the finished command to the host device 200 through the first control part 121.

The first command queue 310 included in the first control part 121 may correspond to the second command queue 320. The first control part 121 may store and manage commands received from the host device 200 in the first command queue 310. When processing of a command is completed by the second control part 122, the first control part 121 may delete the corresponding command from the first command queue 310. The first control part 121 may delete a command stored in the first command queue 310 according to transmission of a response signal by the second control part 122. The size of the first command queue 310 and commands stored in the first command queue 310 may be the same as or correspond to the size of the second command queue 320 and commands stored in the second command queue 320.

The second control part 122 may control the operation of the memory 110 while processing commands stored in the second command queue 320. The second control part 122 may recognize or predict occurrences of an unrecoverable error during operation. When recognizing or predicting an occurrence of an unrecoverable error, the second control part 122 may transmit a reset request preparation signal to the first control part 121. The reset request configuration may mean that the reset request preparation signal is transmitted from the second control part 122 to the first control part 121.

When receiving the reset request preparation signal from the second control part 122, the first control part 121 may prepare for transmitting a reset request to the host device 200.

For example, the first control part 121 may generate a response signal corresponding to at least one command stored in the first command queue 310. The first control part 121 may transmit the generated response signal to the host device 200. The response signal may include information about a reset request. The information regarding a reset request may be transmitted, for example, through the device information field of a response unit corresponding to a command unit.

The first control part 121 may transmit a reset request to the host device 200 through a response signal corresponding to a command whose processing is completed, from among commands stored in the first command queue 310. The first control part 121 may transmit a reset request to the host device 200 through a response signal corresponding to a command whose processing has not yet been completed, from among commands stored in the first command queue 310.

The first control part 121 may transmit reset requests to the host device 200 through response signals corresponding to a plurality of commands stored in the first command queue 310, or may transmit reset requests to the host device 200 through response signals corresponding to all commands stored in the first command queue 310.

In addition, after receiving the reset request preparation signal from the second control part 122, the first control part 121 may automatically transmit information on a reset request to the host device 200 by including the information on a reset request in response signals corresponding to all commands already or subsequently stored in the first command queue 310.

When there is no command stored in the first command queue 310, the first control part 121 may transmit information on a reset request to the host device 200 by including the information about a reset request in a response signal corresponding to a command received from the host device 200 after the first control part 121 receives the reset request preparation signal. For example, the first control part 121 may transmit a reset request to the host device 200 through a response signal corresponding to a first command received from the host device 200 after receiving the reset request preparation signal.

Even if the second control part 122 cannot transmit a response signal corresponding to a command due to occurrence of an unrecoverable error, a reset request may be transmitted to the host device 200 through the first control part 121. For example, there may be a time interval between a time point at which the second control part 122 predicts or recognizes occurrence of an unrecoverable error and a time point at which the controller 120, which includes the second control part 122, transmits a reset request to the host device 200. Since the second control part 122 transmits a reset request preparation signal to the first control part 121 in advance, that is, at a time point at which the second control part 122 predicts or recognizes occurrence of an unrecoverable error, even when the second control part 122 is in an inoperable state due to occurrence of an unrecoverable error, a response signal including a reset request may be transmitted by the first control part 121.

In addition, if the second command queue 320 of the second control part 122 does not operate normally or if there is no command stored in the second command queue 320, then the second control part 122 may set, by a reset request preparation signal, the first control part 121 to transmit a response signal including a reset request.

For example, at a time point at which the second control part 122 predicts or recognizes an occurrence of an unrecoverable error, the second control part 122 may not be able to accurately read a command from the second command queue 320 due to an error. In this case, the second control part 122 may transmit a reset request preparation signal to the first control part 121 so that a response signal including a reset request is transmitted by the first control part 121.

There may be no command stored in the second command queue 320 at a time point at which the second control part 122 predicts or recognizes occurrence of an unrecoverable error. In this case, the second control part 122 cannot transmit a response signal including a reset request and waits until receiving a new command. When a new command is received, the second control part 122 may not operate normally due to an unrecoverable error.

Because the second control part 122 transmits a reset request preparation signal to the first control part 121 in advance, before a new command is received, it is possible to set the first control part 121 so that, when a new command is received, the first control part 121 transmits a response signal including a reset request using the new command stored in the first command queue 310. Therefore, when the second control part 122 does not operate normally at a time point at which a new command is received, the first control part 121 still sends a reset request to the host device 200.

The second control part 122 may set a transmission of a reset request in advance to the first control part 121 using a reset request preparation signal. According to the setting by the second control part 122, the first control part 121 may transmit a response signal including information on a reset request to the host device 200 on the basis of a command stored in the first command queue 310.

Even when the second control part 122 cannot transmit a reset request to the host device 200, a hardware reset signal may be transmitted from the host device 200 according to a reset request transmitted by the first control part 121. At a time point at which a reset request is transmitted by the first control part 121, the second control part 122 may be in a state in which the second control part 122 cannot operate normally. Between a time point at which the first control part 121 transmits a reset request and a time point at which the first control part 121 receives a hardware reset signal, the second control part 122 may be in an inoperable state due to an unrecoverable error. A fast recovery operation of the storage device 100 may be performed by the hardware reset signal.

An operation by the second control part 122 may be controlled, for example, according to firmware to be executed, and an operation by the first control part 121 may be performed by hardware. When an unrecoverable error occurs due to an error in firmware driving, since a reset request may be transmitted by the hardware of the first control part 121, a fast recovery operation may be performed in a situation where occurrence of an unrecoverable error is recognized or predicted.

A reset request by the hardware configuration of the first control part 121 may be performed by, for example, some layers that perform communication with the host device 200.

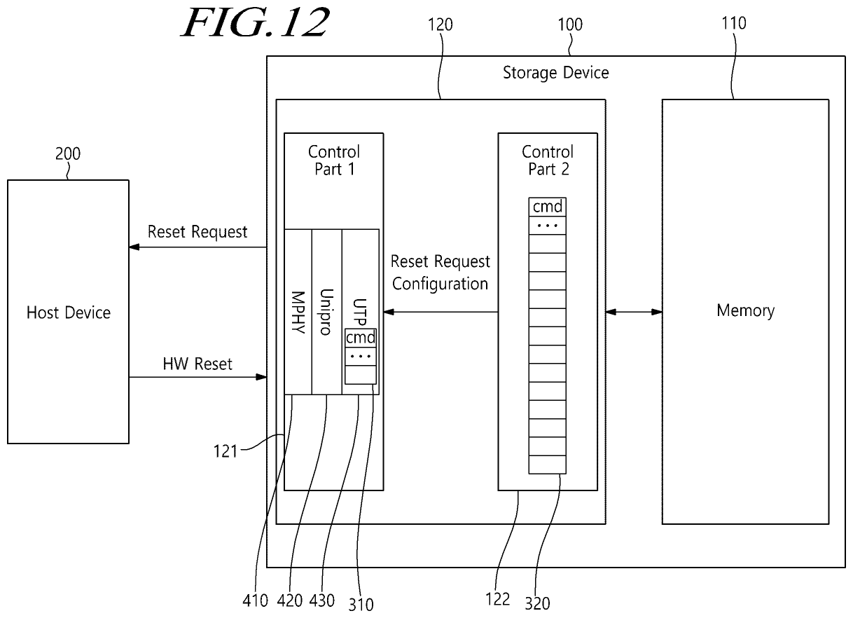

For example, referring to FIG. 12, the first control part 121 of the controller 120 may include a physical layer 410, a data link layer 420 and a transmission protocol layer 430.

The physical layer 410 may perform communication with the host device 200 according to a predetermined protocol. The physical layer 410 may follow the MPHY standard of the Mobile Industry Processor Interface (MIPI). The data link layer 420 may follow the MIPI's Unipro interface. The transmission protocol layer 430 may perform a function of converting signals to be transmitted and received to and from the host device 200 as an upper layer to provide converted signals to the second control part 122. The transmission protocol layer 430 may be a UTP layer, and may convert signals and data to be transmitted and received between the host device 200 and the storage device 100. The transmission protocol layer 430 may follow an interface defined in the UFS standard.

When receiving a reset request preparation signal from the second control part 122, the transmission protocol layer 430 of the first control part 121 may prepare a response signal to be transmitted to the host device 200. A first command queue 310 may be managed by the transmission protocol layer 430 or may be managed outside the transmission protocol layer 430.

According to the received reset request preparation signal, the transmission protocol layer 430 may generate a response signal using a command stored in the first command queue 310. The transmission protocol layer 430 may generate the response signal including information on a reset request. The response signal generated by the transmission protocol layer 430 may be transmitted to the host device 200 through the data link layer 420 and the physical layer 410.

A signal for requesting a reset signal may be easily transmitted to the host device 200 by a hardware configuration included in the first control part 121. Even when an error occurs in firmware driving, transmission of a hardware reset signal may be quickly requested to the host device 200. When an unrecoverable error occurs, the storage device 100 may quickly receive a hardware reset signal from the host device 200, and by performing a recovery operation based on the hardware reset signal, may more rapidly reach the point at which normal operations can resume.

Since the first control part 121 or the second control part 122 transmits a reset request through a response signal based on a command stored in the first command queue 310 or a second command queue 320, a fast recovery operation may be performed variously depending on the command stored in the first command queue 310 or the second command queue 320.

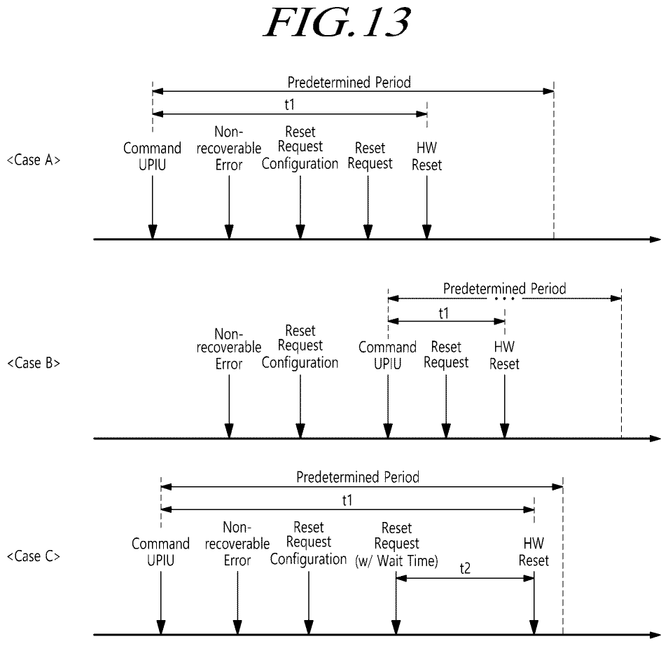

FIG. 13 is a diagram illustrating an example of an operation timing of a storage device according to a reset operation method illustrated in FIG. 10 to FIG. 12.

Referring to <Case A> of FIG. 13, a storage device 100 may receive a command from a host device 200.

When there is no response from the storage device 100 within a predetermined time period after transmitting the command, the host device 200 may transmit various signals for reset of the storage device 100. For example, the host device 200 may transmit a signal to cancel a task according to the command transmitted to the storage device 100, may transmit a signal to cancel the operation of a logic unit including a task, or may transmit a signal for resetting the storage device 100.

When the storage device 100 receives a command from the host device 200 and recognizes or predicts an occurrence of an unrecoverable error, the second control part 122 of the controller 120 may transmit a reset request preparation signal to the first control part 121. The reset request configuration may mean that the reset request preparation signal is transmitted from the second control part 122 to the first control part 121.

When receiving the reset request preparation signal, the first control part 121 may transmit information on a reset request to the host device 200 by including the information on a reset request in a response signal based on a command stored in the first command queue 310. The host device 200 that receives the reset request may immediately transmit a hardware reset signal to the storage device 100.

Transmission of the reset request by the storage device 100 and transmission of the hardware reset signal by the host device 200 may be performed within a time of t1, which is shorter than the predetermined time period.

When an unrecoverable error of the storage device 100 occurs, an operation for recovering the storage device 100 may be performed without waiting until the predetermined time period elapses.

When there is no command already received, the storage device 100 may transmit a reset request after waiting until a new command is received.

For example, referring to <Case B> of FIG. 13, an unrecoverable error of the storage device 100 may occur. The second control part 122 of the storage device 100 may set transmission of a reset request, in advance, by transmitting a reset request preparation signal to the first control part 121. The reset request configuration may mean that the reset request preparation signal is transmitted from the second control part 122 to the first control part 121.

When there is no command stored in the first command queue 310, the first control part 121 may wait until a new command is received. When receiving a new command, the first control part 121 may transmit information on a reset request to the host device 200 through a response signal corresponding to the command.

Without processing a newly received command, the first control part 121 may request transmission of a reset signal to the host device 200 through a response signal corresponding to the command. The host device 200 may transmit a hardware reset signal to the storage device 100 in response to the reset request.

A time of t1, taken from when the command is transmitted to the storage device 100 to when the hardware reset signal is transmitted, may be shorter than a predetermined time period during which the host device 200 waits for a response to the command from the storage device 100. An operation for recovering an error of the storage device 100 may be quickly performed without waiting for the predetermined time period to run.

In some cases, information on a reset request to be transmitted to the host device 200 may include a wait time.

For example, referring to <Case C> of FIG. 13, the storage device 100 may receive a command, and then, may recognize an unrecoverable error. A reset request preparation signal may be transmitted to the first control part 121 by the second control part 122 of the storage device 100. The reset request configuration may mean that the reset request preparation signal is transmitted from the second control part 122 to the first control part 121. The first control part 121 may transmit, to the host device 200, a response signal that corresponds to a command stored in the first command queue 310 and includes information on a reset request. The response signal may include information on a wait time according to the reset request.

When receiving the reset request from the first control part 121, the host device 200 may transmit a hardware reset signal to the storage device 100 after the wait time, according to the reset request, elapses. For example, the host device 200 may transmit the hardware reset signal to the storage device 100 between a time point at which the wait time elapses and a time point at which a predetermined time period elapses.

A time of t2 between a time point at which the reset request is transmitted and a time point at which the hardware reset signal is received may be shorter than the predetermined time period. A time of t1 between a time point at which the host device 200 transmits the command and a time point at which the host device 200 transmits the hardware reset signal may be longer than the time of t2 and shorter than the predetermined time period.

The host device 200 may transmit the hardware reset signal after the wait time elapses, and the controller 120 of the storage device 100 may perform an operation of storing data required in a recovery operation, etc. in the memory 110, during the wait time.

A recovery operation of the storage device 100 may be performed within a time period shorter than the predetermined time period during which the host device 200 waits for a reset operation, and the recovery operation may be performed after the wait time for performing an operation required for recovery of the storage device 100. A fast recovery operation may be efficiently performed by the reset request of the storage device 100.

As the case may be, transmission of a reset signal may be requested through a communication interface or a physical signal line between the host device 200 and the storage device 100 other than the aforementioned signal.

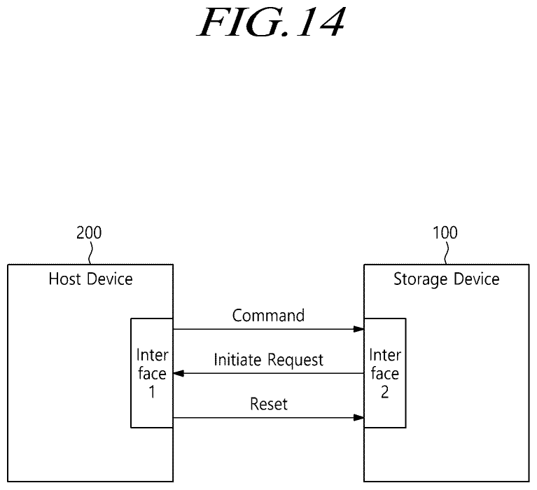

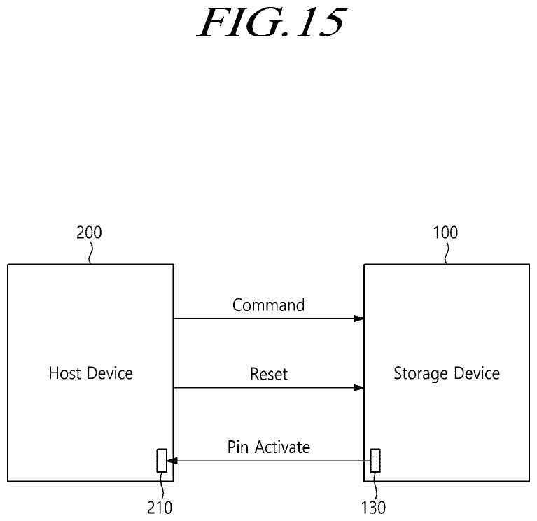

FIG. 14 and FIG. 15 are diagrams illustrating other examples of a reset operation method of a storage device according to embodiments of the present disclosure.

Referring to FIG. 14, a host device 200 and a storage device 100 may transmit and receive signals through a communication interface. For example, communication may be performed between a first interface of the host device 200 and a second interface of the storage device 100.

The storage device 100 may receive a command from the host device 200 through an interface. When an unrecoverable error occurs within a predetermined time period after receiving the command, the storage device 100 may transmit a signal requesting initialization of an interface to the host device 200.

When the host device 200 receives the signal requesting initialization of the interface from the storage device 100 within the predetermined time period, in a state in which the host device 200 transmits a command unit and does not receive a response signal corresponding to the command unit, the host device 200 may recognize that hardware reset is required.

The host device 200 may transmit a hardware reset signal to the storage device 100 in response to the initialization request signal. Fast recovery of the storage device 100 may be performed through the reset signal.

Alternatively, information about the need for reset of the storage device 100 may be provided to the host device 200 through at least one of physical signal lines between the host device 200 and the storage device 100.

For example, referring to FIG. 15, the storage device 100 may include a storage pin 130. The host device 200 may include a host pin 210. The storage pin 130 and the host pin 210 may be connected by a physical signal line. The signal line which connects the storage pin 130 and the host pin 210 may maintain a constant level.

The host device 200 may transmit a command to the storage device 100, and an unrecoverable error of the storage device 100 may occur.

When the unrecoverable error occurs, the storage device 100 may change the level of the signal line that connects the storage pin 130 of the storage device 100 and the host pin 210 of the host device 200, from an existing level.

For example, the signal line that connects the storage pin 130 and the host pin 210 may maintain a first level (e.g., a high level), and when an unrecoverable error is checked by the storage device 100, the level of the corresponding signal line may be changed to a second level (e.g., a low level).

When the level of the signal line that connects the host pin 210 and the storage pin 130 is changed within a predetermined time period after transmitting the command, the host device 200 may recognize that hardware reset of the storage device 100 is required. As the host device 200 transmits a hardware reset signal to the storage device 100, fast recovery of the storage device 100 may be performed.

According to the embodiments of the present disclosure described above, the storage device 100 may transmit, to the host device 200, a hint requesting hardware reset according to an occurrence of an unrecoverable error within a predetermined time period after receiving a command from the host device 200. The storage device 100 may perform fast recovery on the basis of a hardware reset signal, which is transmitted from the host device 200 in response to the hint.

In addition, when an unrecoverable error occurs due to the hardware configuration of the controller 120, by causing a reset request to be transmitted to the host device 200, a reset request may be stably transmitted to the host device 200, and fast recovery based on a hardware reset signal may be efficiently performed.

Accordingly, it is possible to reduce delay time due to occurrence of an unrecoverable error of the storage device 100, which receives a command from the host device 200, and to improve the operational performance of the storage device 100.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A storage device comprising:
a memory; and
a controller including a first control part that communicates with a host device and a second control part that controls the memory,
wherein the second control part recognizes an occurrence of an unrecoverable error, transmits a reset request preparation signal to the first control part, and
wherein after receiving the reset request preparation signal, the first control part transmits, to the host device, a response signal including information on a reset request and corresponding to a command stored in a first command queue for managing commands received from the host device.

2. The storage device according to claim 1, wherein the command stored in the first command queue is not processed.

3. The storage device according to claim 1, wherein the first control part transmits, to the host device, response signals corresponding to all commands stored in the first command queue, and the information on the reset request included in each response signal is the same.

4. The storage device according to claim 1, wherein when there is no command stored in the first command queue, the first control part transmits, to the host device, the response signal including the information on the reset request in response to a first command received from the host device after receiving the reset request preparation signal.

5. The storage device according to claim 1, wherein the first control part includes a physical layer, a data link layer and a transmission protocol layer, and the first control part transmits the response signal corresponding to the command stored in the first command queue to the host device using the transmission protocol layer.

6. The storage device according to claim 1, wherein the first control part transmits the response signal including the information on the reset request to the host device before a predetermined time period, from a time point at which the command stored in the first command queue is received, elapses.

7. The storage device according to claim 6, wherein the first control part receives a hardware reset signal in response to the response signal from the host device before the predetermined time period elapses.

8. The storage device according to claim 7, wherein the second control part is inoperable between a time point at which the first control part transmits the response signal including the information on the reset request to the host device and a time point at which the first control part receives the hardware reset signal from the host device.

9. The storage device according to claim 1, wherein the first control part receives at least one of a task management unit, a logic unit reset signal or a hardware reset signal from the host device after transmitting the response signal to the host device.

10. The storage device according to claim 1, wherein the first control part transmits the information on the reset request to the host device using a device information field included in the response signal.

11. The storage device according to claim 10, wherein the first control part transmits the information on the reset request to the host device using at least one bit other than a bit 1 of the device information field included in the response signal.

12. The storage device according to claim 10, wherein the first control part transmits the information on the reset request to the host device using bits 2 to 5 of the device information field included in the response signal.

13. The storage device according to claim 10, wherein, before receiving a hardware reset signal from the host device, the first control part transmits information on a wait time to the host device using the device information field included in the response signal.

14. The storage device according to claim 13, wherein the first control part receives the hardware reset signal from the host device between a time point at which the wait time elapses and a time point at which a predetermined time period elapses, and the predetermined time period is longer than the wait time.

15. The storage device according to claim 13, wherein the second control part stores data required for recovery after a hardware reset operation in the memory during the wait time.

16. The storage device according to claim 1, wherein the second control part includes a second command queue for managing commands received from the host device, and a size of the second command queue and commands stored in the second command queue are the same as a size of the first command queue and commands stored in the first command queue.

17. A storage device comprising:
a memory; and
a controller configured to control the memory, store and manage commands received from a host device in a command queue, and, when an unrecoverable error is recognized, transmit a response signal, including information on a reset request, that corresponds to at least one command stored in the command queue to the host device.

18. The storage device according to claim 17, wherein the controller transmits the response signal corresponding to the at least one command to the host device when the at least one command stored in the command queue is not performed.

19. The storage device according to claim 17, wherein the controller transmits the response signal including the information on the reset request to the host device and receives a hardware reset signal in response to the response signal from the host device, within a predetermined time period from a time point at which the at least one command is received.

20. A controller comprising:
a first control part configured to communicate with a host device and store and manage a command received from the host device in a command queue; and
a second control part configured to control a memory and transmit a reset request preparation signal to the first control part when an unrecoverable error is recognized,
wherein the first control part, when receiving the reset request preparation signal, transmits a response signal including information on a reset request and corresponding to the command stored in the command queue to the host device.
